(19) United States
(12) Patent Application Publication
(10) Pub. No.: US 2015/0370288 A1
(43) Pub. Date: Dec. 24, 2015

(54) PROTECTIVE ENCLOSURES FOR MOBILE COMPUTING DEVICES

(71) Applicant: Pinakin DINESH, Houston, TX (US)

(72) Inventor: Pinakin DINESH, Houston, TX (US)

(21) Appl. No.: 14/749,567

(22) Filed: Jun. 24, 2015

Related U.S. Application Data
(60) Provisional application No. 62/016,615, filed on Jun. 24, 2014.

(51) Int. Cl. G06F 1/16; H04M 1/18; H04M 1/02

(52) U.S. Cl. CPC G06F 1/1656; H04M 1/0266; H04M 1/185

(57) ABSTRACT

A protective enclosure for a mobile computing device may include a sheet of tempered glass and a shell. The shell may include a first lip defining a first aperture, and a second lip defining a second aperture. The sheet of tempered glass may be coupled to the second lip to substantially block the second aperture. The shell may be configured to receive the mobile computing device such that a front display of the mobile computing device is visible through the first aperture, and a back side of the mobile computing device is visible through the second aperture and the sheet of tempered glass.

### CROSS-REFERENCE TO RELATED APPLICATIONS

This application is based upon and claims the benefit under 35 U.S.C. §119(e) of U.S. Provisional Patent Application Ser. No. 62/016,615, filed Jun. 24, 2014, which is incorporated herein by reference in its entirety for all purposes.

### TECHNICAL FIELD

The present disclosure relates to mobile computing device accessories, and more particularly to protective enclosures/cases for mobile computing devices, such as smart phones, and tablet computers.

### BACKGROUND

In this era of mobile devices, users have many choices of personal mobile computing devices such as, but not limited to, mobile phones, smart phones, tablet computers, personal digital assistants (PDAs), and so forth. The computing devices are loaded with lots of features for the users to help them to do lot many things with the computing device. However, these mobile computing devices are very delicate/sensitive and vulnerable to damage due to elements such as, dust, water etc.

There exist a myriad of generic cases in the market. They usually offer front, side, and back protection for the encased computing device, mostly including protection on the user interface, but leave the screen, charging ports, keypad, headphone's ports, switches, and dock connector ports entirely exposed. Some cases may include a screen protector that is applied as a separate component to the case of the mobile computing device. Such screen protectors are designed solely to protect the screen of the computing device from scratches, but they cannot protect against exposure to dust or moisture.

U.S. Pat. No. 5,896,453 discloses a flexible, plastic, waterproof enclosure wrapped around the circuitry of an electronic device (in this case a cellular phone) inside the phone housing. While providing water proofing for the electronic device, it provides no protection to the screen. Another U.S. Pat. No. 6,785,566 discloses an electronic device case having a foam casing covered in vinyl having a transparent viewing window and hinged openings for the speaker and microphone. The case is designed to absorb impact and protect the device from water and stain. While suitable for the last generation of cellular phones having raised buttons, the foam case is large and cumbersome, running counter to the trend of small and streamlined mobile computing devices and not adapted for use with the touch screen devices available today. In addition, while a transparent window is provided with the case, the windows are not integrated or bonded to the case, and are therefore neither water nor dust resistant.

U.S. Pat. No. 7,312,984 discloses a number of protective case designs, including rigid, hard-shell cases. A number of these protective cases are watertight, crush-resistant and impact-resistant. These cases have an outer shell in the form of an upper and a lower shell that are hingedly connected. A protective membrane is connected to the shell to allow a user to view, and use in the case of a touch screen, the device screen when the device is placed in the protective case. Adapters (for example, a head phone jack) may be disposed within the case.

### BRIEF SUMMARY

Disclosed herein is an improved protective enclosure/case for a mobile computing device such as but not limited to, a smart phone, a mobile phone, a tablet computer, and so forth.

An embodiment of the present disclosure may provide a protective enclosure for a mobile computing device. The protective enclosure may include a sheet of tempered glass and a shell. The shell may include a first lip defining a first aperture, and a second lip defining a second aperture. The sheet of tempered glass may be coupled to the second lip to substantially block the second aperture. Further, the shell may be configured to receive the mobile computing device such that a front display of the mobile computing device is visible through the first aperture, and a back side of the mobile computing device is visible through the second aperture and the sheet of tempered glass.

Another embodiment of the present disclosure may provide a protective enclosure for a mobile computing device. The protective enclosure may include a frame including a first opposing side and a second opposing side. The first opposing side may include a first aperture and the second opposing side includes a second aperture. The protective enclosure may further include a sheet of tempered glass connected to the frame to substantially obstruct the second aperture. The frame may be configured to receive the mobile computing device between the first and the second opposing sides such that a front display of the mobile computing device is visible through the first aperture and a back side of the mobile computing device is visible through the second aperture and the sheet of the tempered glass.

Another embodiment may provide a protective enclosure for a mobile computing device. The protective enclosure may include a shell made of a substantially rigid material. The shell may include an interior surface and an exterior surface. The interior surface may define an interior space for retaining the mobile computing device. The protective enclosure may further include a sheet of tempered glass attached to the interior surface of the shell. The protective enclosure may further include a layer of cushioning material disposed on the exterior surface of the shell.

These and other features will become apparent from the following description of several illustrative embodiments, as shown in the following illustrative drawings.

### BRIEF DESCRIPTION OF THE DRAWINGS

FIG. 1A is a perspective exploded view of an exemplary protective enclosure, in accordance with an embodiment of the present disclosure.

FIG. 1B is another perspective exploded view of the exemplary protective enclosure.

FIG. 2A is a perspective view of an exemplary assembly including a sheet of tempered glass and a PET film layer.

FIG. 2B is a schematic diagram of the assembly of FIG. 2A.

FIG. 2C is a perspective view of a frame portion of a frame of the enclosure of FIGS. 1A and 1B with the glass assembly adhered to a lip of the frame portion by double-sided adhesive tape.

FIG. 3A is an exploded perspective view of the enclosure and a holster for the enclosure.

FIG. 3B is a detailed view showing a compression space between the tempered glass and a sidewall of the frame portion.

FIG. 4 is a detailed perspective view of an interior corner portion of a ring of cushioning material of the enclosure of FIGS. 1A and 1B.

FIGS. 5A-5C show different views of the enclosure encasing a smart phone.

FIGS. 6A-6B shows different views of the enclosure encasing smart phone and disposed in the holster.

FIG. 7A is a perspective view of an interior of the frame portion.

FIG. 7B is a schematic cross-section taken along line 7B-7B in FIG. 7A.

FIG. 7C is a schematic cross-section taken along line 7C-7C in FIG. 7A.

FIG. 8A is a detailed perspective view of a corner portion of the enclosure with the ring disposed on the frame.

FIG. 8B is a schematic cross-section taken along line 8B-8B in FIG. 8A.

FIG. 8C is a schematic cross-section taken along line 8C-8C in FIG. 8A.

FIG. 9 is a perspective view of the frame removed from the ring.

### DETAILED DESCRIPTION

The following detailed description is provided with reference to the figures. Exemplary, and in some case preferred, embodiments are described to illustrate the disclosure, not to limit its scope. Those of ordinary skill in the art will recognize a number of equivalent variations in the description that follows.

The present disclosure provides a protective case/enclosure for mobile computing devices such as, but not limited to, smartphones, tablet computers, and so forth. Herein after the terms protective enclosure and protective case may be used interchangeably. The protective enclosure may have a tempered glass backing and at least four layers of protection. A first layer of the four layers may include a front screen protection that is shatterproof, a second and a third layer are hard layers and may include a polycarbonate (PC) side shell (a hard layer) with embedded tempered glass custom fitted for the device. A fourth layer of the four layers may include a Thermoplastic Rubber (TPR) ring for side drop protection. The TPR ring may be a cushion layer over the polycarbonate (PC) ring, which provides access to all the side buttons. The PC ring may also include one or more dust ports to protect ports of the mobile computing device from dust. Furthermore, the disclosed enclosure can also be paired with an optional holster for ease in carrying. These four layers may work together to ensure that the enclosure is scratch proof, dust proof, and shatter proof.

Further, the tempered glass backing may include at least one PET film for protecting the tempered glass from shattering in case the glass breaks upon impact with an external object. Further, there may be a gap between the PC shell and the tempered glass. The tempered glass may be spaced at least 0.2 millimeter (mm) smaller than the actual PC shell to ensure that in case the mobile computing device drops with the case being on it, then the impact is only on the PC shell. The PC shell may bounce off the impact and may not affect the actual device and the tempered glass.

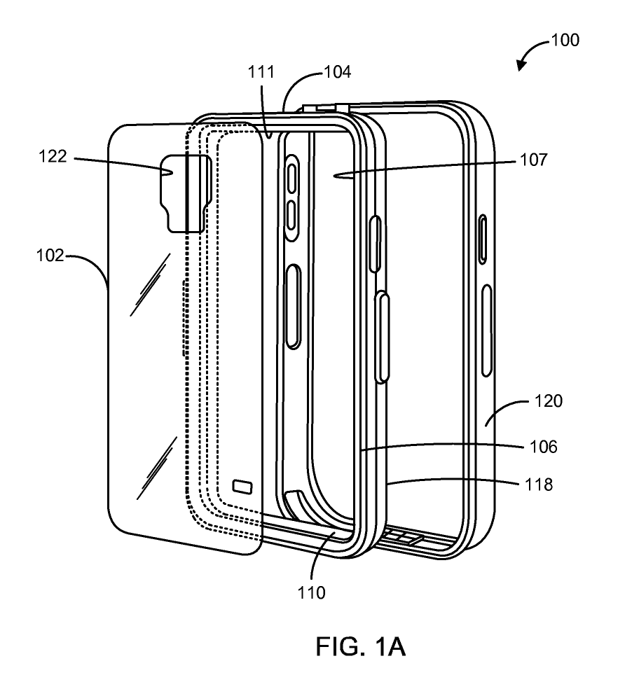

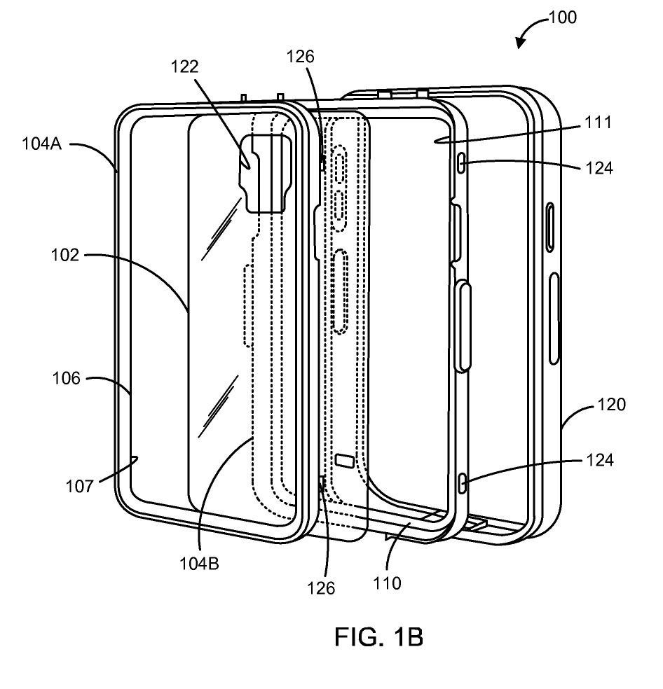

FIG. 1 is a perspective exploded view of an exemplary protective enclosure 100, in accordance with an embodiment of the present disclosure. The protective enclosure 100 includes a sheet of tempered glass 102, and a shell (or frame) 104. The shell 104 includes a first opposing side having a first lip 106, and a second opposing side having a second lip 110. First lip 106 may define a first aperture 107, and second lip 110 may define a second aperture 111. The sheet of tempered glass 102 may be fixed (or attached, or coupled) to the second lip 110 to substantially block second aperture 111. The shell 104 may made of a rigid material such as, but not limited to, polycarbonate (PC).

The shell 104 may include a sidewall 118 configured to connect (e.g., selectively connect) first lip 106 to second lip 110. Further, the shell 104 may be configured to receive a mobile computing device (not shown) between the first lip 106 and the second lip 110 such that a front display of the mobile computing device is visible through first aperture 107, and a back side of the mobile computing device (e.g., opposite the front display) is visible through second aperture 111 and sheet 102. Examples of the mobile computing device may include, but are not limited to, a smart phone, a tablet computer, a mobile phone, and so forth. The shell 104 may have different colors. In an embodiment, the first lip 106 and the second lip 110 of the shell 104 may have different colors.

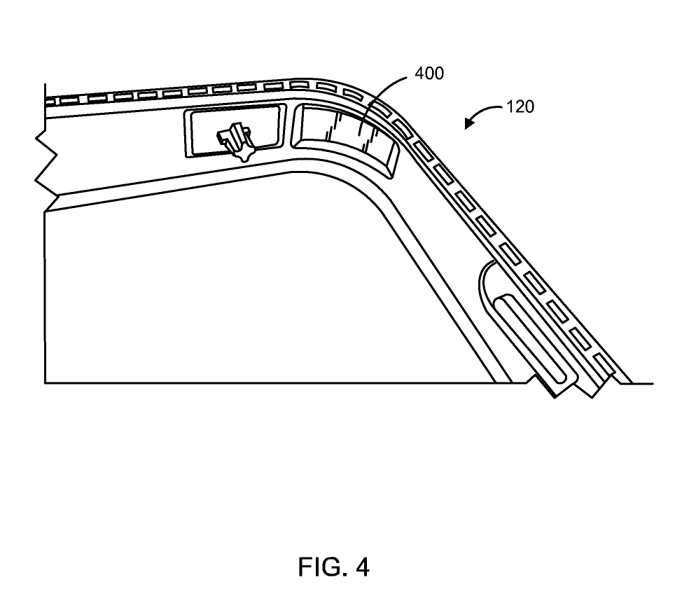

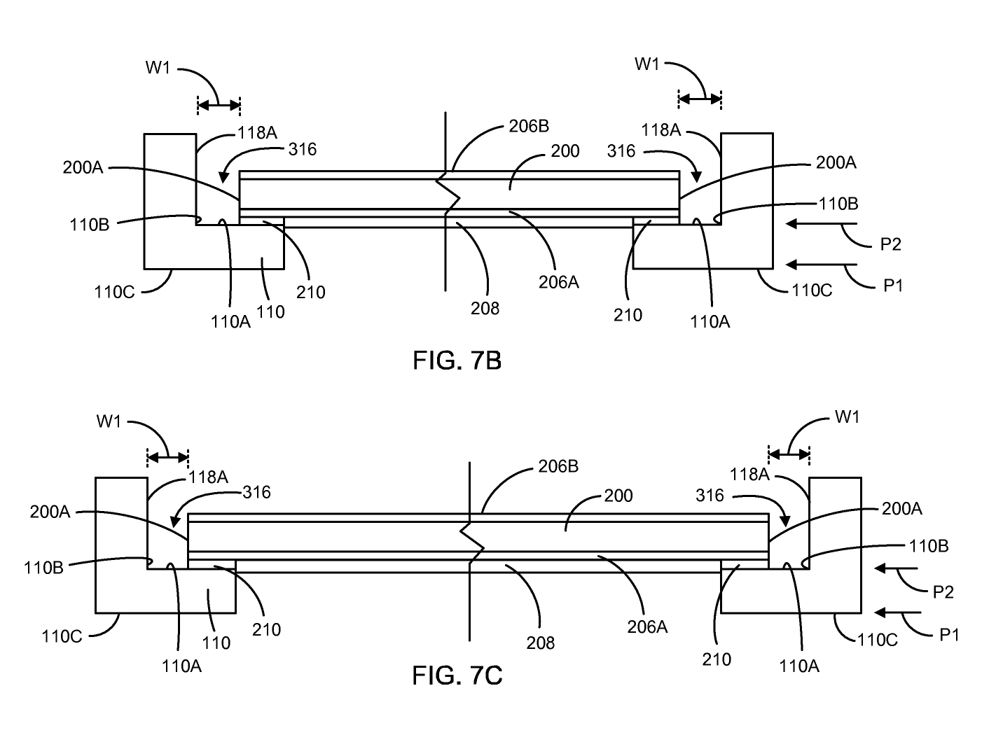

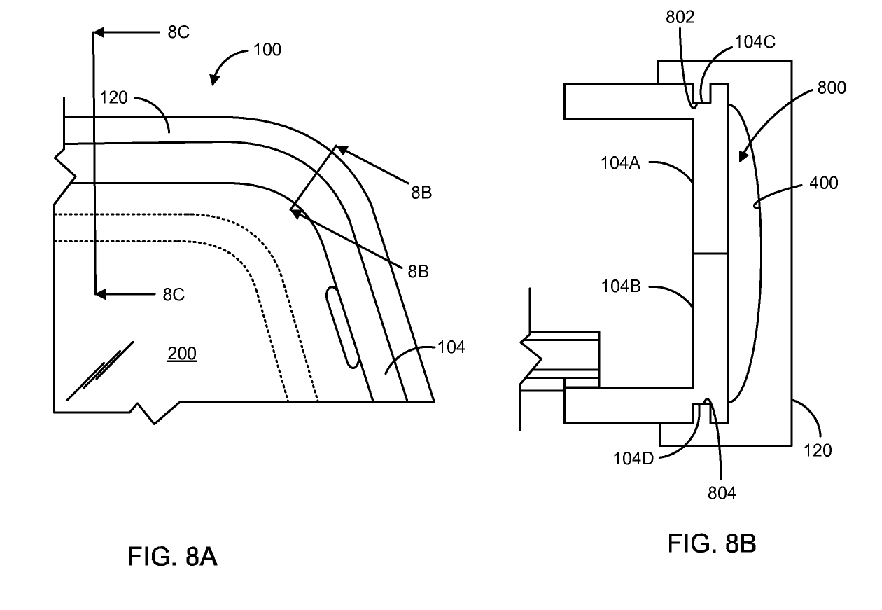

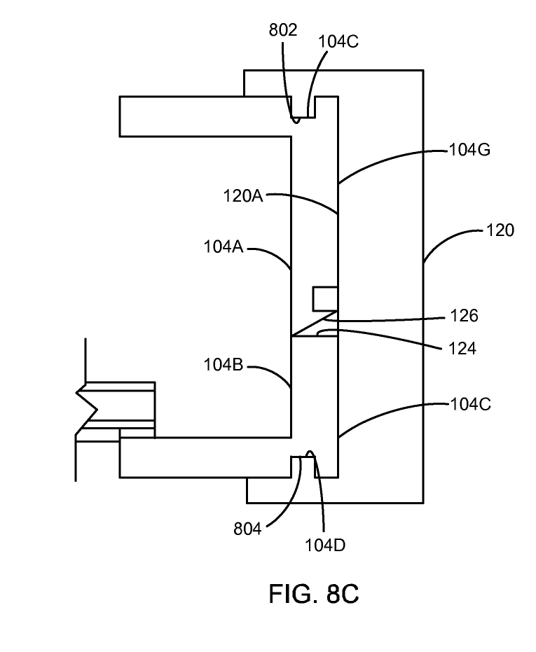

The shell 104 may have varied shapes and sizes. In some embodiments, the shell 104 is rectilinear in shape. Further, the shape may include one or more corners, such as first, second, thirst, and fourth frame corners. The enclosure 100 may also include a ring 120 of cushioning material having a corresponding generally rectilinear shape similarly characterized by first, second, third, and fourth ring corners. Further, the shape of the cushioning material may correspond with shape of the shell 104. In an embodiment, the cushioning material of ring 120 may be thermoplastic rubber (TPR). Such a thermoplastic elastomer may have a density that is suitably light and/or provides for suitable cushioning. Disposing ring 120 around shell 104 may form air cushions implemented in the four corners of the shell 104 to reduce any external impact. The ring may be configured to surround the shell 104 such that the first, second, third, and fourth ring corners cover the first, second, third, and fourth shell corners of the shell 104, respectively. The first, second, third, and fourth ring corners may include respective recessed interior surfaces (e.g., see 400 in FIGS. 4 and 8B) that may provide respective compression void spaces between the first shell corner and the first ring corner, between the second shell corner and the second ring corner, between the third shell corner and the third ring corner, and between the fourth shell corner and the fourth ring corner.

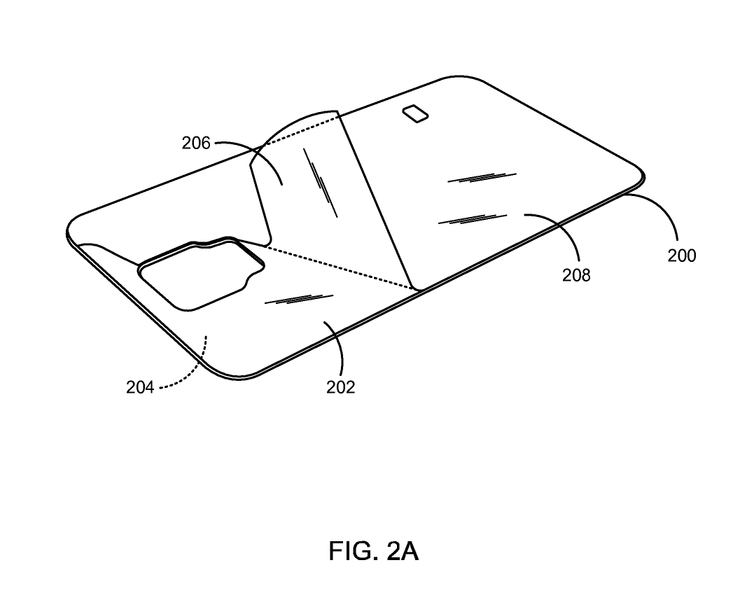

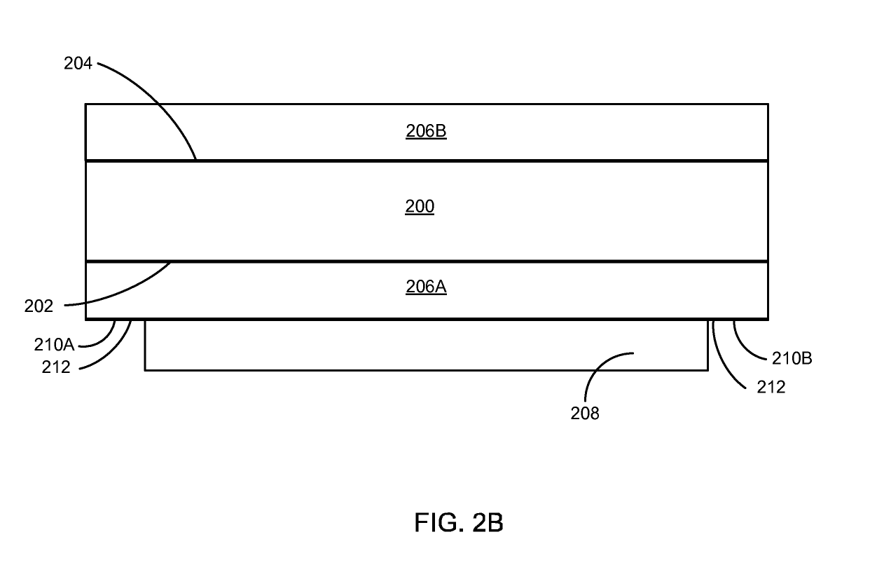

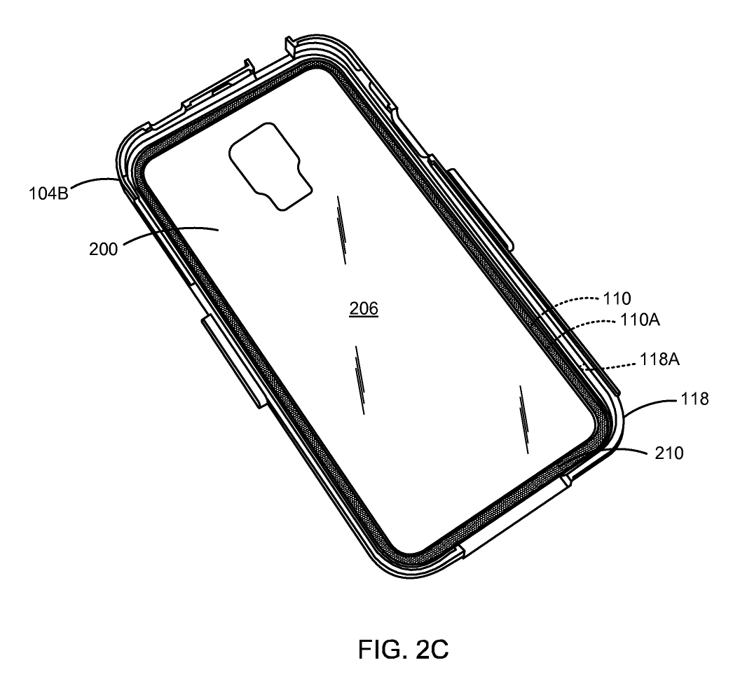

As shown, the sheet of tempered glass 102 may include one or more holes (e.g., hole 122), which may be configured to align with a camera aperture and a camera flash of the mobile computing device. The sheet of tempered glass 102 is discussed in detail with reference to FIGS. 2A-2C.

FIG. 1B shows a perspective exploded view of the exemplary protective enclosure of FIG. 1A showing the first lip 106 and the second lip 110, in accordance with an embodiment of the present disclosure. As described above, first lip 106 defines a first aperture 107 and the second lip 110 defines a second aperture 111. The sheet of the tempered glass 102 is coupled to the second lip 110 so as to substantially block the second aperture 111 of the second lip 110. The shell 104 is configured to receive the mobile computing device between the first lip 104 and the second lip 110. When the mobile computing device is encased within the enclosure, a front display of the mobile computing device is visible through the first aperture 107 and a back side of the mobile computing device is visible through the second aperture 111 and the sheet of tempered glass 102.

The shell 104 may also include one or more tabs 126 and one or more slots 124 that are selectively engageable with the one or more tabs 124. In some embodiments, the one or more tabs 126 may be located or formed on a first frame portion 104a (e.g., which may include first lip 106) of frame 104, and the one or more slots 124 may be located or formed on a second frame portion 104b (e.g., which may include second lip 110) of frame 104. The one or more tabs 126 can be disengaged from the one or more slots 124 to provide for the first lip 106 and the second lip 110 to be at least partially separated from one another to allow for the mobile computing device to be received in frame 104. The tabs and the slots can be engaged with one another to couple together frame portions 104a, 104b. The engagement of the one or more tabs 126 with the one or more slots 124 may substantially prevent movement of the first lip 106 relative to the second lip 110. In some embodiments, tabs 126 and the slots 124 may interlock to ensure proper fixing of the first lip 106 with respect to the second lip 110. Though not seen in FIG. 1B due to the perspective of the view, corresponding long sides of frame portions 104a, 104b and corresponding shorter top sides of frame portions 104a, 104b may similarly including interlocking tabs and slots.

FIG. 2A shows a perspective view of an exemplary sheet of tempered glass 200, which is an example of sheet 102. For example, sheet of tempered glass 200 may be similar in structure and function to sheet of tempered glass 102. Further, the sheet of tempered glass 200 (or 102) may include two faces, such as a first major face 202 and a second major face 204. The first major face 202 and the second major face 204 are opposite sides of the sheet of tempered glass 200. The protective enclosure 100 may further include a polyethylene terephthalate (PET) film 206 disposed on the first major face 202 of the sheet of tempered glass 200. In FIG. 2A, film 206 is shown pulled away from a portion of face 202 to distinguish between these components. However, when glass 200 is coupled to the second lip, this pulled away portion of film 206 would normally also be in contact with (and adhered to) face 202.

In some embodiments, at least two PET films (e.g., a first PET film 206A, and a second PET film 206B disposed on the first major face 202 and the second major face 204, respectively) may be coupled to sheet 200 to sandwich sheet 200 therebetween. FIG. 2B shows a block diagram depicting first PET film 206A and second PET film 206B disposed on the sheet of tempered glass 200. Further, each of the PET films 206A-206B may include a first major face and a second major face (not shown) opposite to each other. The first major face of the PET film, such as of PET film 206A, may contact the first major face 202 of the sheet of tempered glass 200. The second major face of the PET film 206 may include at least one perimeter region 212. The sheet of tempered glass 200 may be coupled to second lip 110, as shown in FIG. 2C, via the first PET film 206A in perimeter region 212. Perimeter region 212 may form a continuous region, which may extend all the way around a perimeter of the sheet of tempered glass 200 and/or a perimeter of film 206A. Herein after, the first and second PET films 206A-206B may be referred to as PET film 206.

Referring back to FIG. 2B, the protective enclosure 100 may include an anti-fingerprint coating 208 disposed on a second major face of the PET film 206A. In an embodiment, the anti-fingerprint coating 208 is on a second major face of the first PET film 206A.

FIG. 2C shows frame portion 104b with sheet 200 coupled to an interior surface 110a of second lip 110. Interior surface 110a may be substantially perpendicular to an interior surface 118a of sidewall 118. Further, an outer perimeter of the interior surface 110a of the second lip 110 may be connected to interior surface 118a of the sidewall 118.

Perimeter region 212 of the PET film 206 may be connected to the interior surface 110a of the second lip 110 using a suitable adhesive. In some embodiments, the perimeter region 212 of the second major face of the PET film 206 may be connected to the interior surface 110a of the second lip 110 using double-sided adhesive tape 210 in adhesion zones 210A-210B (See FIG. 2B) on film 206A. For example, a 3M double tape may be used. Further, adhesion zone 210A-210B on film 206A may extend around the whole perimeter of the sheet of tempered glass 200 to correspond with the location of tape 210, as shown in FIG. 2C.

In some embodiments, the protective enclosure 100 may also include the anti-fingerprint coating 208 disposed on the second major face of the PET film 206 but not on the perimeter region 212 of the PET film 206. This may be achieved by first fixing sheet 200 to second lip 110 via film 206A and tape 210, and then applying coating 208 to film 206A that is exposed through the second aperture. By applying coating 208 to film 206A outside of the perimeter region of film 206A that is coupled to the second lip via the double-sided tape, a secure attachment of the tempered glass to the frame may be achieved. For example, if coating 208 was applied to film 206A before coupling the tempered glass to the frame, then coating 208 may extend between the tempered glass and the double-sided tape, which may result in a less secure attachment (e.g., the double-sided tape may not adhere well to coating 208, for example, due to the physical and/or chemical properties of coating 208).

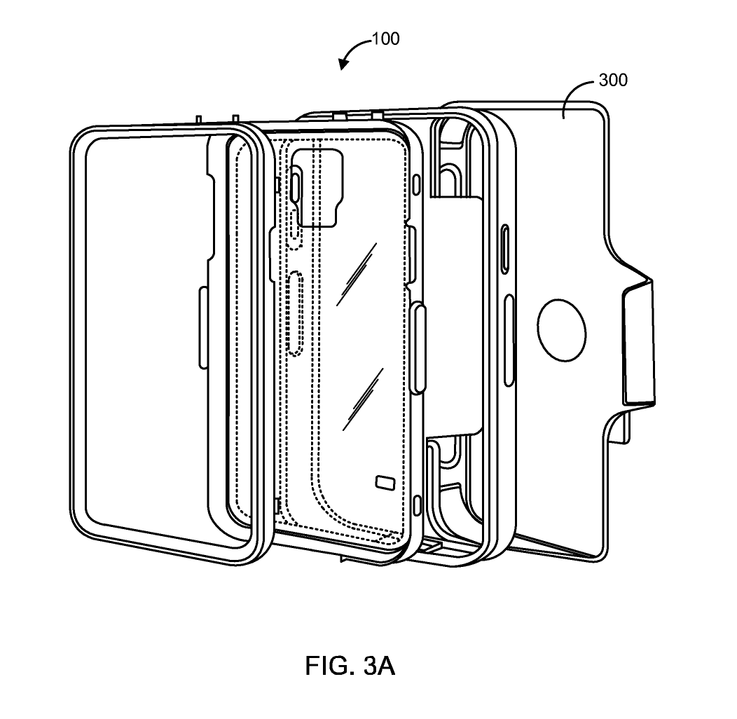

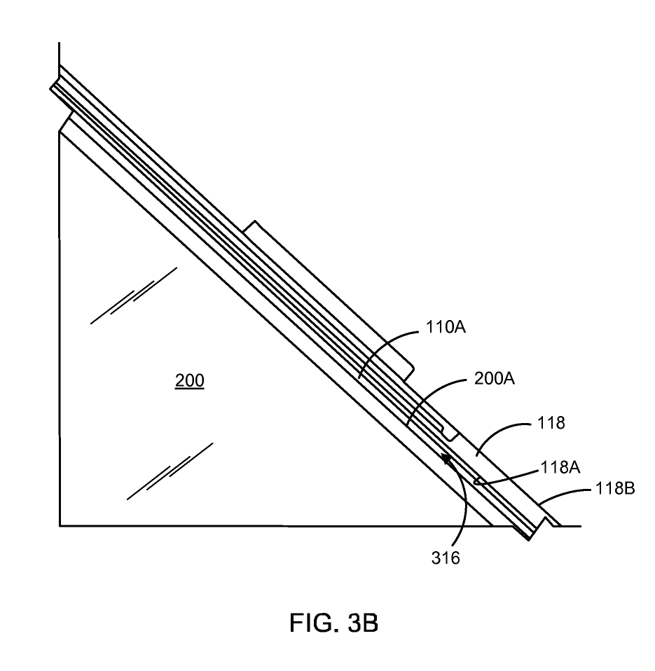

FIG. 3A shows a holster 300 in which enclosure 300 may be selectively held and carried. The holster 300 may be configured to be coupled to a user's belt and/or may provide a grip for a hand of the user and makes it easier for the user to hold the mobile computing device.

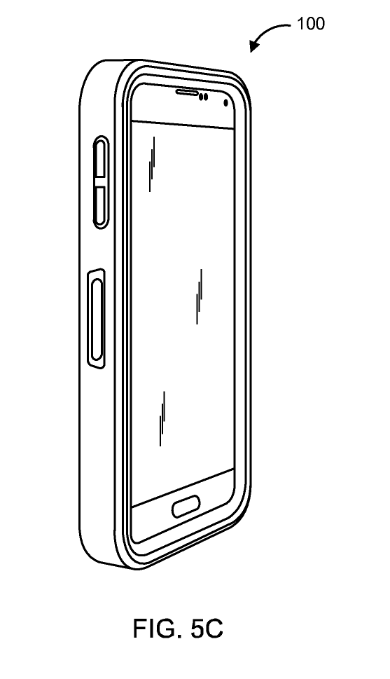

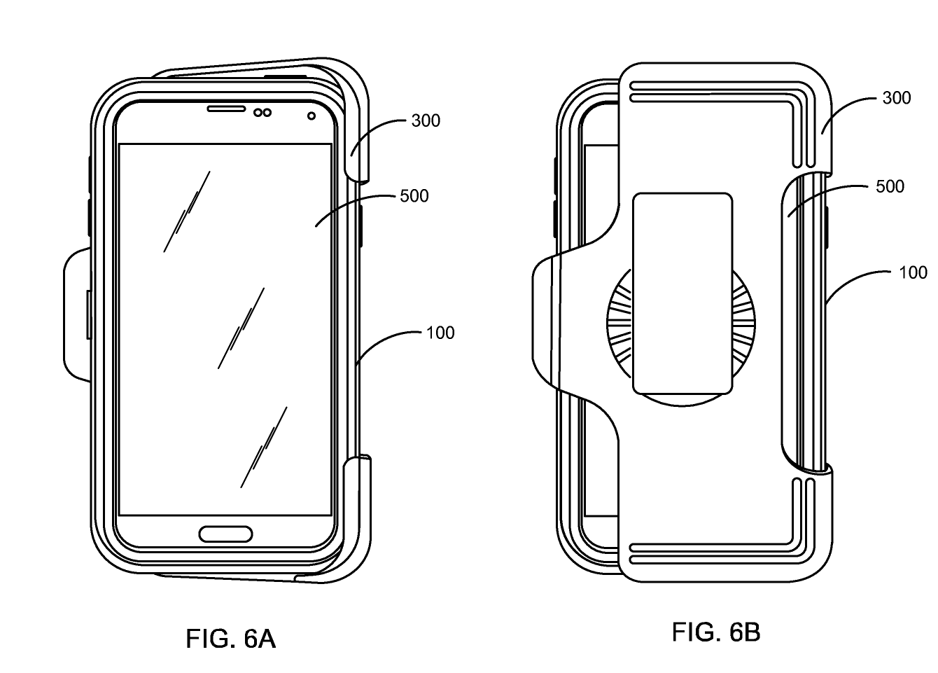

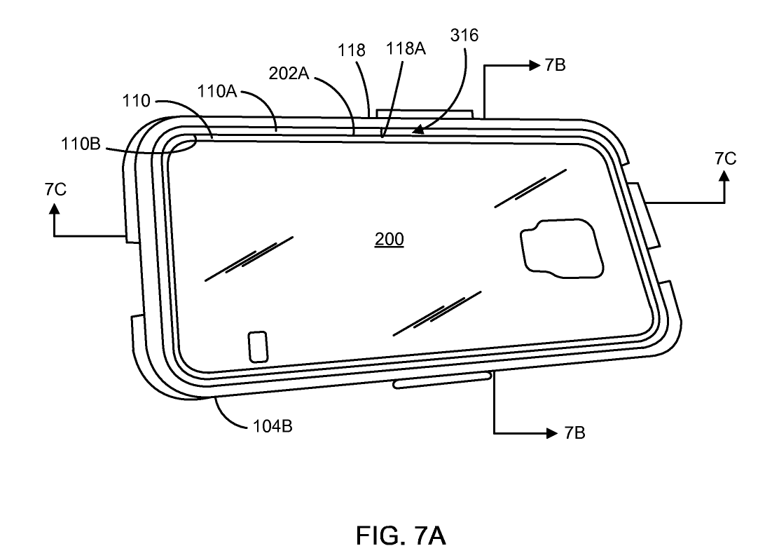

FIG. 3B shows a top view of sidewall 118 of the shell, and a compression space 316 disposed between the outer perimeter of sheet 200 and interior surface 118a of sidewall 118 along interior surface 110a of the second lip. The second lip may further include a thickness extending between an exterior surface of the second lip and interior surface 110a, which is depicted schematically in FIGS. 7B and 7C. As discussed with reference to FIGS. 2A-2C, the sheet of tempered glass 200 may be coupled to the interior surface of the second lip 110 using the PET film 206. Further, the PET film 206 and the sheet of tempered glass 200 may be at least spaced apart from a plane defined by the exterior surface of the second lip to prevent a substantially planar object from exert a force on the sheet of tempered glass 200 via the second aperture.

As shown in FIG. 3B, an outer perimeter of the sheet of tempered glass 302 may be down-sized relative to the outer perimeter 200a of the interior surface of the second lip to provide compression space 316. Compression space 316 may have a width extending between the interior surface 118a of the sidewall 118 and perimeter 200a of the sheet of tempered glass along interior surface 110a of the second li. The compression space 316 may prevent forces exerted on an exterior surface 118b of the sidewall 118 from being directly transferred to the sheet of tempered glass 200 from the interior surface of the sidewall 118. For example, the sheet of tempered glass 200 may be spaced 0.2 mm away from interior surface 118a. This may ensure that in case the protective enclosure 100 (containing the mobile computing device) drops, that the impact may be only on (or substantially only upon, or substantially absorbed by) the shell 104, which may bounce off the impact, and thus may protect the mobile computing device and prevent the sheet tempered glass 302 from breaking.

FIG. 4 shows a portion of ring 120. As shown previously (e.g., see FIG. 1A), ring 120 may have a rectilinear shape characterized by a first, second, third, and fourth ring corners. However, FIG. 4 shows only one corner of the ring 120, but a person skilled in the art will appreciate that the ring 120 can include four corners.

As discussed above, the protective enclosure 100 may include ring 120 made of cushioning material (such as TPR) having a corresponding generally rectilinear shape characterized by the first, second, third, and fourth ring corners. Further, the shape of the cushioning material may be in accordance (or correspond) with shape of the sheet of tempered glass 102 (or 200). The TPR ring around the shell 104 may include provide for compression void spaces (e.g., an air cushion) implemented in the four corners of ring 120 to reduce any external impact. The ring may be configured to surround the shell 104 such that the first, second, third, and fourth ring corners cover the first, second, third, and fourth shell corners, respectively. The first, second, third, and fourth ring corners may include respective recessed interior surfaces, such as recessed surface 400, that provide respective compression void spaces between the first shell corner and the first ring corner, between the second shell corner and the second ring corner, between the third shell corner and the third ring corner, and between the fourth shell corner and the fourth ring corner when ring 120 is disposed on the exterior surface of shell 104.

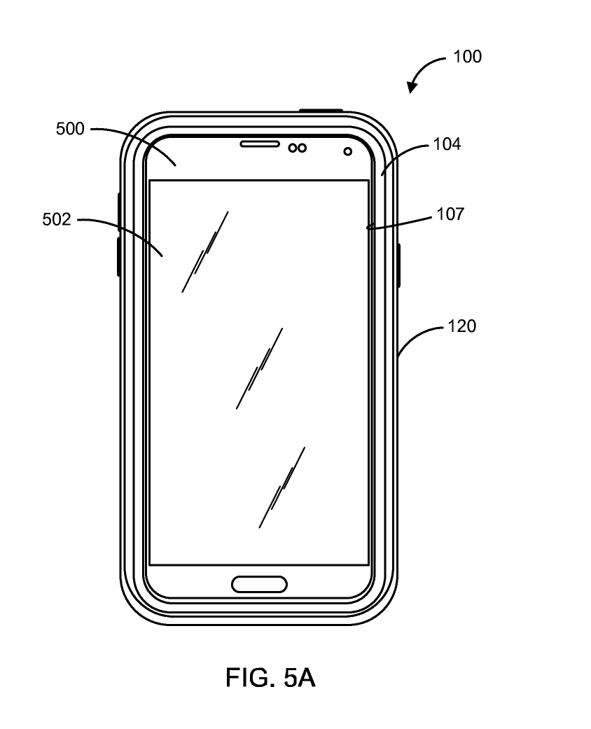

FIG. 5A shows a front view of the protective enclosure 100 enclosing a smart phone 500. The interior space of the shell 104 of the protective enclosure 100 may be configured to receive the smart phone 500 such that a front display 502 (e.g., a touch responsive display) of mobile computing device 500 is visible through the first aperture 107.

FIG. 5B shows a back view of the protective enclosure 100 enclosing the smart phone 500. As shown, a majority of a back side 504 of the smart phone 500 is visible through the second aperture 111 and the sheet of tempered glass 200 when the smart phone is retained in the interior space of the shell 104. As shown, a hole is formed through sheet 200, which aligns with a camera aperture 506 and a camera flash 508, which may be included in back side 504 of device 500.

FIG. 5C shows a side view 500C of the protective enclosure 100 enclosing the smart phone.

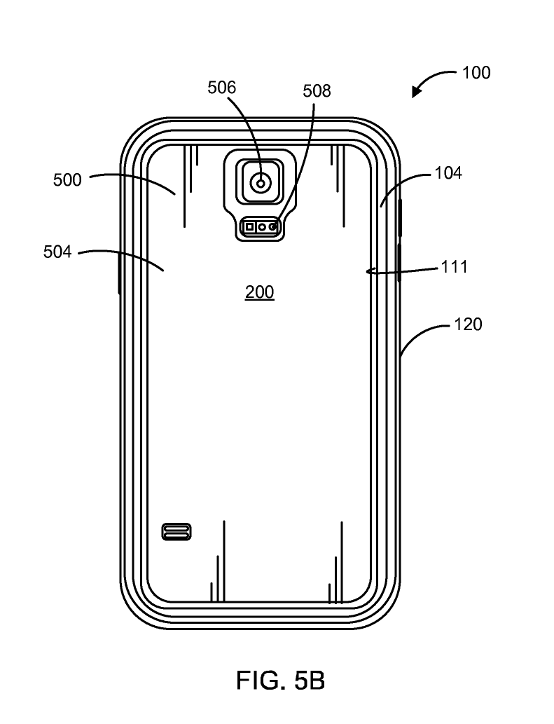

FIGS. 6A-6B show enclosure 100 removably held in holster 300, with device 500 contained in the interior space of enclosure 100. FIG. 6A shows a front view of holster 300 and enclosure 100 enclosing the smart phone 500. FIG. 6B shows a back view of holster 300 and enclosure 100 enclosing the smart phone 500.

FIG. 7A shows frame portion 104B with sheet 200 coupled to second lip 110. a schematic view of a second lip 700 including a sheet of tempered glass 702. As previously described, the second lip 110 has interior surface 110A which may be connected to interior surface 118A of sidewall 118. Outer perimeter 200A of the sheet of tempered glass 200 may be down-sized relative to an outer perimeter 110B of interior surface 110A of second lip 110. Further, as previously described, compression space or gap 316 may be disposed between the interior surface 118A and the outer perimeter 200A of the sheet of the tempered glass 200.

FIG. 7B shows a schematic cross-section of frame portion 104B and the tempered glass taken along line 7B-7B in FIG. 7A. Similarly, FIG. 7C shows a schematic cross-section of frame portion 104B and the tempered glass taken along line 7C-7C in FIG. 7A. As shown, the compression space 316 has a width W1, with width W1 being substantially constant between perimeter 200A and interior surface 118A around the entire perimeter 200A. As shown, the outer perimeter region of the PET film 206A may be connected to the interior surface 110A of the second lip with double sided tape 210. A plane P1 defined by exterior surface 110C of lip 110 may be spaced apart from and substantially parallel to plane P2 defined by interior surface 110A of lip 110. Lip 110 may have a thickness that extends between planes P1 and P2.

The anti-fingerprint coating 208 may prevent fingerprints from remaining on that portion of the enclosure when a user uses the mobile computing device. In some embodiments, anti-fingerprint coating may be similarly disposed on the second major face of the PET film 206B.

FIG. 8A shows perspective view of a portion of enclosure 100, with ring 120 disposed on shell 104, and sheet 200 connected to the second lip.

FIG. 8B is a cross section taken along line 8B-8B in FIG. 8A, and FIG. 8C is a cross-section taken along line 8C-8C. The ring of cushioning material may be disposed all over an outer perimeter of the shell to clamp or otherwise secure together the first and second frame portions. As previously described, ring 120 may include recessed interior surface 400 in each of the four ring corners, such that a compression zone 800 (e.g., compression spaces, which may be void spaces occupied entirely by air or may be filled with another suitable compressible material) is formed between each of the ring corners and each of the frame corners. When ring 120 is disposed on the shell, a first flange 802 of ring 120 may engage a first groove 104C in frame portion 104A, and a second flange 804 of ring 120 may engage a second groove 104D in frame portion 104B. Such engagement may prevent the engaged tabs and slots, such as engaged tab and slot 126, 124 (shown in FIG. 8C), from disengaging. As also shown in FIG. 8C, an interior surface 120A of 120 ring may contact an exterior surface 104G of the shell (or frame), and in some embodiments may contact a majority of the perimeter of exterior surface 104G extending around the outer most portion of the rectilinear shape of the shell.

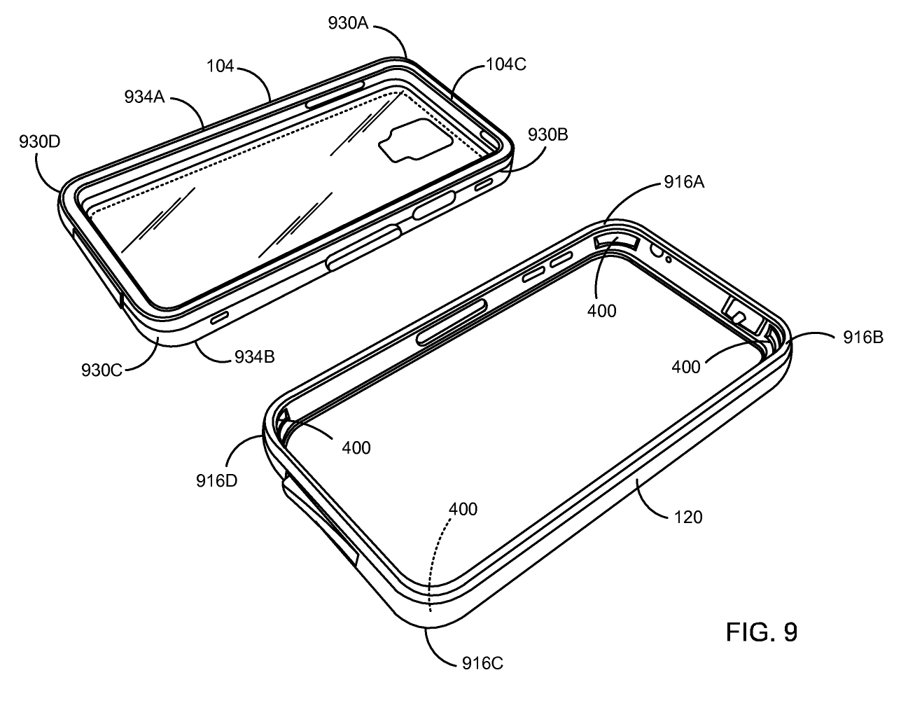

FIG. 9 shows a perspective view of the enclosure with ring 120 removed from frame 104. As shown the enclosure may include frame 104, the sheet of tempered glass and ring 120. The frame may include first and second opposing sides 104E, 104F. Groove 104C may extend around a majority (e.g., the entire) perimeter region of first opposing side 104E, similarly, groove 104D may extend around a majority (e.g., the entire) perimeter region of second opposing side 104F.

As previously described, the sheet of tempered glass may be connected to the frame to substantially obstruct the second aperture. Further, the frame may include an interior surface. The frame may be configured to receive the mobile computing device between the first and second opposing sides 934A,934B such that a front display of the mobile computing device is visible through the first aperture, and a back side of the mobile computing device is visible through the second aperture and the sheet of tempered glass. The sheet of tempered glass may include a first major face and a second major face.

The frame may include one or more frame corners (or shell corners), such as a first corner 930A, a second corner 930B, a third corner 930C, and a fourth corner 930D. The frame may include one or more tabs and one or more slots that are selectively engageable with the one or more tabs. The one or more tabs may be disengaged from the one or more slots when the first and second frame portions, are at least partially separated. The engagement of the one or more tabs with the one or more slots may be configured to substantially prevent movement of the first frame portion relative to the second frame portion. In FIG. 9, the tabs are engaged with the slots.

The sheet of tempered glass may be connected to the interior surface of the second lip. The shell may include a sidewall that connects the first lip to the second lip. The interior surface of the second lip may be substantially perpendicular to an interior surface of the sidewall with an outer perimeter of the interior surface of the second lip being connected to the interior surface of the sidewall. An outer perimeter of the sheet of tempered glass may be down-sized relative to the outer perimeter of the interior surface of the second lip to provide a compression void space having a width extending between the interior surface of the sidewall and the outer perimeter of the sheet of tempered glass and along the interior surface of the second lip to prevent forces exerted on an exterior surface of the sidewall from being directly transferred to the sheet of tempered glass from the interior surface of the sidewall.

The first and second portions of the frame may be at least partially separable from one another for reception of the mobile computing device. The first and second portions may be first and second portions of the sidewall that connects together the first and second opposing sides.

The ring of cushioning material may be selectively disposable on an exterior surface of the frame. The exterior surface of the frame may include the first and second opposing grooves. The first groove may extend around the perimeter region of the first side 934A. The second groove may extend around the perimeter region of the second side 934B. Also, as previously described, the ring of cushioning material may include opposing first and second flanges 802, 804 that respectively extend into the first and second grooves when the ring of cushioning material is disposed on the exterior surface of the frame thereby hindering disengagement of the one or more tabs from the one or more slots.

The ring and the frame may have substantially corresponding rectilinear shapes each characterized by respective first, second, third, and fourth corners. The ring may include a sidewall that connects the first and second flanges 802, 804. The first, second, third, and fourth corners 920A-920D of the ring may cover the respective first, second, third, and fourth corners 930A-930D of the frame and a majority of the interior surface of the sidewall of the ring may contact the exterior surface of the frame when the ring is disposed on the exterior surface of the frame.

Further, the interior surface of the ring may be recessed in at least one of the corners 920A-920D of the ring 914 to create a compression zone between the ring and a corresponding corner (such as 930A-930D) of the frame 902. As indicated in FIG. 9, ring 120 includes recessed surfaces 400 in each of the interior corners of the ring.

The disclosed enclosure may ensure that any external impact to the mobile computing device is totally eliminated and/or reduced. Further, the sheet of tempered glass, polycarbonate shell, and the Thermoplastic Rubber (TPR) ring may make the case light weight and ensures full protection of the encased mobile computing device.

Embodiments of the present disclosure may provide a protective enclosure for a mobile computing device. The protective enclosure may include a frame including a first opposing side and a second opposing side. The first opposing side may includes a first aperture and the second opposing side includes a second aperture. The protective enclosure may further include a sheet of tempered glass connected to the frame to substantially obstruct the second aperture. The frame may be configured to receive the mobile computing device between the first and the second opposing sides such that a front display of the mobile computing device is visible through the first aperture and a back side of the mobile computing device is visible through the second aperture and the sheet of the tempered glass.

The first side may include a first lip that defines the first aperture, and the second side may include a second lip that defines the second aperture. The sheet of tempered glass may remain connected to an interior surface of the second lip. Further, the shell may include a sidewall connecting the first lip to the second lip. The interior surface of the second lip may be substantially perpendicular to an interior surface of the sidewall with an outer perimeter of the interior surface of the second lip being connected to the interior surface of the sidewall. An outer perimeter of the sheet of tempered glass being down-sized relative to the outer perimeter of the interior surface of the second lip to provide a compression void space (or gap). The compression void space may have a width extending between the interior surface of the sidewall and the outer perimeter of the sheet of tempered glass and along the interior surface of the second lip. The compression void space may prevent forces exerted on an exterior surface of the sidewall from being directly transferred to the sheet of tempered glass from the interior surface of the sidewall.

Further, the shell may include a first portion and a second portion that are at least partially separable from one another for reception of the mobile computing device. In some embodiments, the first portion and the second portion are first and second portions of a sidewall that connects together the first and second opposing sides. Further, the frame may include one or more tabs and one or more slots that are selectively engageable with the one or more tabs. The tabs being disengaged from the one or more slots when the first and second portions are at least partially separated. The engagement of the one or more tabs with the one or more slots may be configured to substantially prevent movement of the first frame portion relative to the second frame.

The disclosed enclosure may also include a ring of cushioning material that may be selectively disposable on an exterior surface of the frame. In an embodiment, the ring may be a Thermoplastic Rubber (TPR) ring. The exterior surface of the frame may include first and second opposing grooves such that the first groove extends around a perimeter region of the first side, and the second groove extends around a perimeter region of the second side. The ring of cushioning material may include opposing first and second flanges that respectively extend into the first and second grooves when the ring of cushioning material is disposed on the exterior surface of the frame thereby hindering disengagement of the one or more tabs from the one or more slots.

Further, the shape and/or size of the ring may correspond with the shape and/or size of the frame. In an embodiment, the ring and the frame may have substantially corresponding rectilinear shapes each characterized by respective first, second, third, and fourth corners. Further, the ring may include a sidewall that connects the first and second flanges. Furthermore, the first, second, third, and fourth corners of the ring may cover the respective first, second, third, and fourth corners of the frame and a majority of the interior surface of the sidewall of the ring may contact the exterior surface of the frame when the ring is disposed on the exterior surface of the frame. Further, the interior surface of the ring may be recessed in at least one of the corners of the ring to create a compression zone between the ring and a corresponding corner of the frame.

An embodiment of the present disclosure may provide a protective enclosure for a mobile computing device. The protective enclosure may include a shell made of a substantially rigid material. The shell may include an interior surface and an exterior surface. The interior surface may define an interior space for retaining the mobile computing device. The protective enclosure may further include a sheet of tempered glass attached to the interior surface of the shell. The protective enclosure may further include a layer of cushioning material disposed on the exterior surface of the shell. In some embodiments, the substantially rigid material of the shell may be polycarbonate, and the cushioning material may be thermoplastic elastomer. The shell may further include a first lip and a second lip that respectively define first and second apertures. Further, a front display of the mobile computing device may be visible through the first aperture and a majority of a back side of the mobile computing device may be visible through the second aperture and the sheet of tempered glass when the mobile computing device is retained in the interior space of the shell.

In some embodiments, one or more holes may be formed through the sheet of tempered glass, the one or more holes being configured to align with a camera aperture and a camera flash included in the mobile computing device. The enclosure may further include a PET film, an anti-fingerprint coating, and a double-sided adhesive tape. The shell may include first and second opposing lips that respectively define first and second apertures. Further, a first major face of the PET film may contact a first major face of the sheet of tempered glass. The PET film may also include a second major face opposite the first major face of the PET film. Further, the anti-fingerprint coating may be disposed on the second major face of the PET film such that a perimeter region of the second major face of the PET film is not covered by the anti-fingerprint coating. Furthermore, the double-sided tape adhesive tape attaches the sheet of tempered glass to the second lip via the perimeter region.

In an embodiment, the protective enclosure also includes a holster that may allow a user to hold the mobile computing device easily and hence reduces the chance of the mobile phone slipping out of user's hand. Further, the holster may allow the user to attach the mobile computing device on his/her belt etc.

This following describes additional aspects and features of a protective enclosure, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.

A0. A protective enclosure for a mobile computing device, the enclosure comprising a sheet of tempered glass; and a shell including a first lip defining a first aperture, and a second lip defining a second aperture, the sheet of tempered glass being coupled to the second lip to substantially block the second aperture, the shell being configured to receive the mobile computing device such that a front display of the mobile computing device is visible through the first aperture and a back side of the mobile computing device is visible through the second aperture and the sheet of tempered glass.

A1. The enclosure of paragraph A0, wherein the sheet of tempered glass has opposing first and second major faces, the enclosure further including a polyethylene terephthalate (PET) film disposed on the first major face of the sheet of tempered glass, the sheet of tempered glass being coupled to the second lip via the PET film.

A2. The enclosure of paragraph A1, wherein the second lip has an exterior surface defining a first plane, an interior surface defining a second plane that is spaced apart from the first plane and substantially parallel to the first plane, and a thickness extending between the exterior and interior surfaces, the sheet of tempered glass being coupled to the interior surface of the second lip via the PET film such that the PET film and the sheet of tempered glass are at least spaced apart from the first plane by the thickness to prevent a substantially planar object from exerting a force on the sheet of tempered glass via the second aperture.

A3. The enclosure of paragraph A2, wherein the shell includes a sidewall that connects the first lip to the second lip, the interior surface of the second lip being substantially perpendicular to an interior surface of the sidewall, an outer perimeter of the interior surface of the second lip being connected to the interior surface of the sidewall, an outer perimeter of the sheet of tempered glass being down-sized relative to the outer perimeter of the interior surface of the second lip to provide a compression space having a width extending between the interior surface of the sidewall and the sheet of tempered glass along the interior surface of the second lip to prevent forces exerted on the exterior surface of the sidewall from being directly transferred to the sheet of tempered glass from the interior surface of the sidewall.

A4. The enclosure of paragraph A2, further including double-sided adhesive tape, the PET film including opposing first and second major faces, the first major face of the PET film contacting the first major face of the sheet of tempered glass, the second major face of the PET film including a perimeter region that is connected to the interior surface of the second lip by the double-sided adhesive tape.

A5. The enclosure of paragraph A4, further including an anti-fingerprint coating disposed on the second major face of the PET film but not on the perimeter region of the PET film.

A6. The enclosure of paragraph A0, wherein the shell has a generally rectilinear shape characterized by first, second, third, and fourth shell corners, the enclosure further comprising a ring of cushioning material having a corresponding generally rectilinear shape characterized by first, second, third, and fourth ring corners, the ring being configured to surround the shell such that the first, second, third, and fourth ring corners respectively cover the first, second, third, and fourth shell corners, the first, second, third, and fourth ring corners including respective recessed interior surfaces that provide respective compression void spaces between the first shell corner and the first ring corner, between the second shell corner and the second ring corner, between the third shell corner and the third ring corner, and between the fourth shell corner and the fourth ring corner.

A7. The enclosure of paragraph A6, wherein the cushioning material is thermoplastic rubber.

B0. A protective enclosure for a mobile computing device, the enclosure comprising: a frame including first and second opposing sides having respective first and second apertures; and a sheet of tempered glass connected to the frame to substantially obstruct the second aperture; wherein the frame is configured to receive the mobile computing device between the first and second opposing sides such that a front display of the mobile computing device is visible through the first aperture and a back side of the mobile computing device is visible through the second aperture and the sheet of tempered glass.

B1. The enclosure of paragraph B0, wherein the first side includes a first lip that defines the first aperture, and the second side includes a second lip that defines the second aperture, the sheet of tempered glass being connected to an interior surface of the second lip, the shell including a sidewall that connects the first lip to the second lip, the interior surface of the second lip being substantially perpendicular to an interior surface of the sidewall with an outer perimeter of the interior surface of the second lip being connected to the interior surface of the sidewall, an outer perimeter of the sheet of tempered glass being down-sized relative to the outer perimeter of the interior surface of the second lip to provide a compression void space having a width extending between the interior surface of the sidewall and the outer perimeter of the sheet of tempered glass and along the interior surface of the second lip to prevent forces exerted on an exterior surface of the sidewall from being directly transferred to the sheet of tempered glass from the interior surface of the sidewall.

B2. The enclosure of paragraph B0, wherein the frame includes first and second portions that are at least partially separable from one another for reception of the mobile computing device.

B3. The enclosure of paragraph B2, wherein the first and second portions are first and second portions of a sidewall that connects together the first and second opposing sides.

B4. The enclosure of claim B2, wherein the frame includes one or more tabs and one or more slots that are selectively engagable with the one or more tabs, the one or more tabs being disengaged from the one or more slots when the first and second portions are at least partially separated, engagement of the one or more tabs with the one or more slots being configured to substantially prevent movement of the first frame portion relative to the second frame portion.

B5. The enclosure of paragraph B4, wherein the enclosure includes a ring of cushioning material that is selectively disposable on an exterior surface of the frame, the exterior surface of the frame including first and second opposing grooves, the first groove extending around a perimeter region of the first side, the second groove extending around a perimeter region of the second side, the ring of cushioning material including opposing first and second flanges that respectively extend into the first and second grooves when the ring of cushioning material is disposed on the exterior surface of the frame thereby hindering disengagement of the one or more tabs from the one or more slots.

B6. The enclosure of paragraph B5, wherein the ring and the frame have substantially corresponding rectilinear shapes each characterized by respective first, second, third, and fourth corners, the ring including a sidewall that connects the first and second flanges, the first, second, third, and fourth corners of the ring covering the respective first, second, third, and fourth corners of the frame and a majority of the interior surface of the sidewall of the ring contacting the exterior surface of the frame when the ring is disposed on the exterior surface of the frame.

B7. The enclosure of paragraph B6, wherein the interior surface of the ring is recessed in at least one of the corners of the ring to create a compression zone between the ring and a corresponding corner of the frame.

C0. A protective enclosure for a mobile computing device, the enclosure comprising: a shell made of a substantially rigid material, the shell including an interior surface and an exterior surface, the interior surface defining an interior space for retaining the mobile computing device; a sheet of tempered glass attached to the interior surface of the shell; and a layer of cushioning material disposed on the exterior surface of the shell.

C1. The enclosure of paragraph C0, wherein the substantially rigid material is polycarbonate, the cushioning material being thermoplastic elastomer, the shell including first and second lips that respectively define first and second apertures, and a front display of the mobile computing device being visible through the first aperture and a majority of a back side of the mobile computing device being visible through the second aperture and the sheet of tempered glass when the mobile computing device is retained in the interior space of the shell.

C2. The enclosure of paragraph C1, wherein one or more holes are formed through the sheet of tempered glass, the one or more holes being configured to align with a camera aperture and a camera flash included in the mobile computing device.

C3. The enclosure of paragraph C0, further including PET film, an anti-fingerprint coating, and double-sided adhesive tape, wherein the shell includes first and second opposing lips that respectively define first and second apertures, a first major face of the PET film contacting a first major face of the sheet of tempered glass, the PET film including a second major face opposite the first major face of the PET film, the anti-fingerprint coating being disposed on the second major face of the PET film such that a perimeter region of the second major face of the PET film is not covered by the anti-fingerprint coating, the double sided tape adhesive tape attaching the sheet of tempered glass to the second lip via the perimeter region.

From the foregoing description it will be apparent that numerous changes and variations are possible in various embodiments, and it is to be understood that the foregoing description is intended to be illustrative of the present teaching, not limiting thereof.

Accordingly, it will be readily apparent that many other embodiments and variations may be designed based upon the principles of the present disclosure. Therefore, it is to be understood that the foregoing description is purely illustrative rather than limiting of the disclosure.

The above disclosure is provided for exemplary purposes. Changes may be made in details, particularly in matters of shape, size, and arrangement of steps without exceeding the scope of the disclosure. This may include, to the extent that it is appropriate, the use of any of the features of one example embodiment being used in other embodiments.

What is claimed:

1. A protective enclosure for a mobile computing device, the enclosure comprising:
a sheet of tempered glass; and
a shell including a first lip defining a first aperture, and a second lip defining a second aperture, the sheet of tempered glass being coupled to the second lip to substantially block the second aperture, the shell being configured to receive the mobile computing device such that a front display of the mobile computing device is visible through the first aperture and a back side of the mobile computing device is visible through the second aperture and the sheet of tempered glass.

2. The enclosure of claim 1, wherein the sheet of tempered glass has opposing first and second major faces, the enclosure further including a polyethylene terephthalate (PET) film disposed on the first major face of the sheet of tempered glass, the sheet of tempered glass being coupled to the second lip via the PET film.

3. The enclosure of claim 2, wherein the second lip has an exterior surface defining a first plane, an interior surface defining a second plane that is spaced apart from the first plane and substantially parallel to the first plane, and a thickness extending between the exterior and interior surfaces, the sheet of tempered glass being coupled to the interior surface of the second lip via the PET film such that the PET film and the sheet of tempered glass are at least spaced apart from the first plane by the thickness to prevent a substantially planar object from exerting a force on the sheet of tempered glass via the second aperture.

4. The enclosure of claim 3, wherein the shell includes a sidewall that connects the first lip to the second lip, the interior surface of the second lip being substantially perpendicular to an interior surface of the sidewall, an outer perimeter of the interior surface of the second lip being connected to the interior surface of the sidewall, an outer perimeter of the sheet of tempered glass being down-sized relative to the outer perimeter of the interior surface of the second lip to provide a compression space having a width extending between the interior surface of the sidewall and the sheet of tempered glass along the interior surface of the second lip to prevent forces exerted on the exterior surface of the sidewall from being directly transferred to the sheet of tempered glass from the interior surface of the sidewall.

5. The enclosure of claim 3, further including double-sided adhesive tape, the PET film including opposing first and second major faces, the first major face of the PET film contacting the first major face of the sheet of tempered glass, the second major face of the PET film including a perimeter region that is connected to the interior surface of the second lip by the double-sided adhesive tape.

6. The enclosure of claim 5, further including an anti-fingerprint coating disposed on the second major face of the PET film but not on the perimeter region of the PET film.

7. The enclosure of claim 1, wherein the shell has a generally rectilinear shape characterized by first, second, third, and fourth shell corners, the enclosure further comprising a ring of cushioning material having a corresponding generally rectilinear shape characterized by first, second, third, and fourth ring corners, the ring being configured to surround the shell such that the first, second, third, and fourth ring corners respectively cover the first, second, third, and fourth shell corners, the first, second, third, and fourth ring corners including respective recessed interior surfaces that provide respective compression void spaces between the first shell corner and the first ring corner, between the second shell corner and the second ring corner, between the third shell corner and the third ring corner, and between the fourth shell corner and the fourth ring corner.

8. The enclosure of claim 7, wherein the cushioning material is thermoplastic rubber.

9. A protective enclosure for a mobile computing device, the enclosure comprising:
a frame including first and second opposing sides having respective first and second apertures; and
a sheet of tempered glass connected to the frame to substantially obstruct the second aperture;
wherein the frame is configured to receive the mobile computing device between the first and second opposing sides such that a front display of the mobile computing device is visible through the first aperture and a back side of the mobile computing device is visible through the second aperture and the sheet of tempered glass.

10. The enclosure of claim 9, wherein the first side includes a first lip that defines the first aperture, and the second side includes a second lip that defines the second aperture, the sheet of tempered glass being connected to an interior surface of the second lip, the shell including a sidewall that connects the first lip to the second lip, the interior surface of the second lip being substantially perpendicular to an interior surface of the sidewall with an outer perimeter of the interior surface of the second lip being connected to the interior surface of the sidewall, an outer perimeter of the sheet of tempered glass being down-sized relative to the outer perimeter of the interior surface of the second lip to provide a compression void space having a width extending between the interior surface of the sidewall and the outer perimeter of the sheet of tempered glass and along the interior surface of the second lip to prevent forces exerted on an exterior surface of the sidewall from being directly transferred to the sheet of tempered glass from the interior surface of the sidewall.

11. The enclosure of claim 9, wherein the frame includes first and second portions that are at least partially separable from one another for reception of the mobile computing device.

12. The enclosure of claim 11, wherein the first and second portions are first and second portions of a sidewall that connects together the first and second opposing sides.

13. The enclosure of claim 11, wherein the frame includes one or more tabs and one or more slots that are selectively engagable with the one or more tabs, the one or more tabs being disengaged from the one or more slots when the first and second portions are at least partially separated, engagement of the one or more tabs with the one or more slots being configured to substantially prevent movement of the first frame portion relative to the second frame portion.

14. The enclosure of claim 13, wherein the enclosure includes a ring of cushioning material that is selectively disposable on an exterior surface of the frame, the exterior surface of the frame including first and second opposing grooves, the first groove extending around a perimeter region of the first side, the second groove extending around a perimeter region of the second side, the ring of cushioning material including opposing first and second flanges that respectively extend into the first and second grooves when the ring of cushioning material is disposed on the exterior surface of the frame thereby hindering disengagement of the one or more tabs from the one or more slots.

15. The enclosure of claim 14, wherein the ring and the frame have substantially corresponding rectilinear shapes each characterized by respective first, second, third, and fourth corners, the ring including a sidewall that connects the first and second flanges, the first, second, third, and fourth corners of the ring covering the respective first, second, third, and fourth corners of the frame and a majority of the interior surface of the sidewall of the ring contacting the exterior surface of the frame when the ring is disposed on the exterior surface of the frame.

16. The enclosure of claim 15, wherein the interior surface of the ring is recessed in at least one of the corners of the ring to create a compression zone between the ring and a corresponding corner of the frame.

17. A protective enclosure for a mobile computing device, the enclosure comprising:
a shell made of a substantially rigid material, the shell including an interior surface and an exterior surface, the interior surface defining an interior space for retaining the mobile computing device;
a sheet of tempered glass attached to the interior surface of the shell; and
a layer of cushioning material disposed on the exterior surface of the shell.

18. The enclosure of claim 17, wherein the substantially rigid material is polycarbonate, the cushioning material being thermoplastic elastomer, the shell including first and second lips that respectively define first and second apertures, and a front display of the mobile computing device being visible through the first aperture and a majority of a back side of the mobile computing device being visible through the second aperture and the sheet of tempered glass when the mobile computing device is retained in the interior space of the shell.

19. The enclosure of claim 18, wherein one or more holes are formed through the sheet of tempered glass, the one or more holes being configured to align with a camera aperture and a camera flash included in the mobile computing device.

20. The enclosure of claim 17, further including PET film, an anti-fingerprint coating, and double-sided adhesive tape, wherein the shell includes first and second opposing lips that respectively define first and second apertures, a first major face of the PET film contacting a first major face of the sheet of tempered glass, the PET film including a second major face opposite the first major face of the PET film, the anti-fingerprint coating being disposed on the second major face of the PET film such that a perimeter region of the second major face of the PET film is not covered by the anti-fingerprint coating, the double sided tape adhesive tape attaching the sheet of tempered glass to the second lip via the perimeter region.
